(19) United States
(12) Patent Application Publication
(10) Pub. No.: US 2025/0054712 A1
(43) Pub. Date: Feb. 13, 2025

(54) PUSH BUTTON WITH CONSISTENT EDGE PERFORMANCE USING ONE OR MORE DOME SWITCHES

(71) Applicant: Microsoft Technology Licensing, LLC, Redmond, WA (US)

(72) Inventors: Yi-Yen LIN, Taipei (TW); Jun YE, Suzhou (CN); Jian ZUO, Suzhou (CN)

(21) Appl. No.: 18/719,425

(22) PCT Filed: Dec. 24, 2021
(86) PCT No.: PCT/CN2021/141091

§ 371 Date: Jun. 13, 2024

(51) Int. Cl. H01H 13/52; H01H 13/04

(52) U.S. Cl. CPC H01H 13/52; H01H 13/04; H01H 2215/026; H01H 2217/004; H01H 2221/026; H01H 2221/058

(57) ABSTRACT

Dome switches can provide inconsistent positive tactile feedback, particularly when depressed around the edges of a corresponding push button as compared to depression at the middle of the push button. Various arrangements intended to render push buttons that incorporate one or more dome switches more consistent in providing positive tactile feedback, while maintaining a reasonable ease and cost of manufacturing, are discussed herein. A push button with consistent edge performance using a single dome switch incorporates a hinge arm that spans button posts. This reduces or eliminates rotation deflection of a button cap caused by the torsional forces on the push button created by depression forces applied by the user at an edge of the push button. As a result, the dome switch provides a predictable and consistent positive tactile feedback to the user similar to that achieved by a centrally applied depression force.

### BACKGROUND

Push buttons for mobile computing devices often utilize dome switches (e.g., metal dome switches and polydomes) due to their compact size, positive tactile feedback, and ability to reliably withstand a large number of depression and release cycles.

### SUMMARY

Implementations described and claimed herein provide a push button comprising: a chassis including at least two button post apertures, a dome switch mounted within the chassis, a button cap including a user interface surface on one side of the button cap and at least two button posts extending from an opposite side of the button cap, the at least two button posts each extending through one of the at least two button post apertures, and a hinge arm spanning the dome switch and a distal end of each of the at least two button posts, wherein the hinge arm is rotationally mounted to the chassis.

Implementations described and claimed herein further provide a method of actuating a push button comprising receiving an actuation force on a user interface surface on one side of a button cap, transmitting the actuation force through at least two button posts extending from an opposite side of the button cap, the at least two button posts each extending through one of at least two button post apertures in a chassis, transmitting the actuation force from the at least two button posts to a hinge arm spanning a dome switch and a distal end of each of the at least two button posts, wherein the dome switch mounted within the chassis, and wherein the hinge arm is rotationally mounted to the chassis, and depressing the dome switch using the hinge arm.

Implementations described and claimed herein still further provide a fingerprint-sensing power button for a computing device comprising a chassis including at least two button post apertures, a dome switch mounted within the chassis, and a button cap. The button cap includes a fingerprint sensor, a user interface surface on one side of the button cap, and at least two button posts on an opposite side of the button cap, the at least two button posts each extending through one of the at least two button post apertures. The power button further comprises a hinge arm spanning the dome switch and a distal end of each of the at least two button posts, wherein the hinge arm is rotationally mounted to the chassis.

Other implementations are also described and recited herein. This Summary is provided to introduce a selection of concepts in a simplified form that are further described below in the Detailed Descriptions. This Summary is not intended to identify key features or essential features of the claimed subject matter, nor is it intended to be used to limit the scope of the claimed subject matter.

### BRIEF DESCRIPTIONS OF THE DRAWINGS

FIG. 1 illustrates a perspective view of an example mobile computing device with a push button having consistent edge performance while using a single dome switch.

FIG. 2A illustrates a first elevation view of an example push button having consistent edge performance while using a single dome switch.

FIG. 2B illustrates a second elevation view of the example push button of FIG. 2A.

FIG. 3A illustrates several views of another example push button having consistent edge performance while using a single dome switch.

FIG. 3B illustrates an exploded perspective view of the example push button of FIG. 3A.

FIG. 4A illustrates several views of another example push button having consistent edge performance while using a single dome switch.

FIG. 4B illustrates an exploded perspective view of the example push button of FIG. 4A.

FIG. 5A illustrates several views of another example push button having consistent edge performance while using a single dome switch.

FIG. 5B illustrates an exploded perspective view of the example push button of FIG. 5A.

FIG. 6 illustrates example operations for actuating a push button having consistent edge performance while using a single dome switch.

### DETAILED DESCRIPTIONS

Dome switches can provide inconsistent positive tactile feedback, particularly when depressed around the edges of a corresponding push button as compared to depression at the middle of the push button. Further, power buttons with dual-dome switches may resolve some tactile feedback issues, but such power buttons require an additional electrical circuit and the associated cost. Still further, power buttons with dual-dome switches can still result in inconsistent depressing force across button surface (e.g., double depressing force at middle comparing to the depressing forces at end points). Various arrangements intended to render push buttons that incorporate one or more dome switches more consistent in providing positive tactile feedback, while maintaining a reasonable ease and cost of manufacturing, are discussed herein.

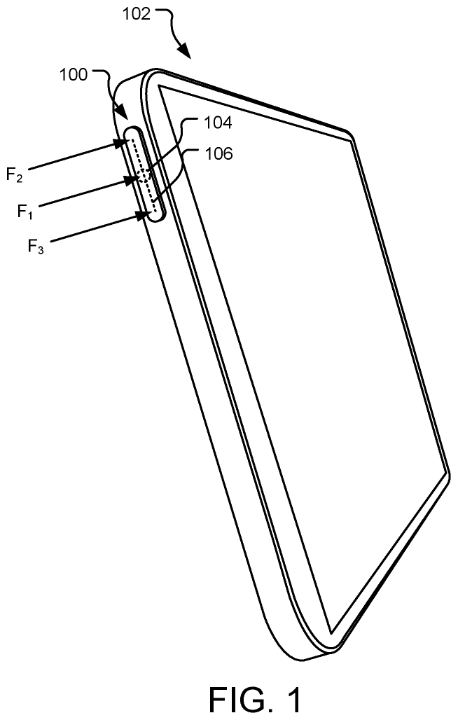

FIG. 1 illustrates a perspective view of an example mobile computing device 102 with a push button 100 having consistent edge performance while using a single dome switch 104. The dome switch 104 is a metal or rubber dome switch. A metal dome switch is a formed piece of metal (e.g., stainless steel) that, when compressed, give the user a crisp, positive tactile feedback. The metal dome switch may be reliable to over 5 million cycles, and can be plated in either nickel, silver or gold for consistent electrical conductivity and corrosion resistance. A rubber dome switch, referred to herein as a polydome, is a formed polyurethane dome where the inside bubble is coated in graphite for electrical conductivity. While the polydome is cheaper, it lacks the crisp snap, has a larger physical stroke, and has a lower life specification as compared to a typical metal dome. Further, while the polydome is quiet when cycled, it does not provide as much positive response to the user as compared to a typical metal dome.

For either the metal or the rubber dome switch 104, when the push button 100 is pressed, it collapses the dome switch 104, which connects two underlying circuit traces and completes a connection to electrically signify depression of the push button 100. Similarly, when the push button 100 is released, the dome switch 104 rebounds, which disconnects the two underlying circuit traces to electrically signify release of the push button 100. The dome switch 104 is centered on the push button 100 but installed behind the push button 100 inside the device 102. Thus, the dome switch 104 is illustrated in broken lines as it is not visible from the exterior of the device 102.

Arrow F₁ illustrates a depression force applied by a user centrally on the push button 100. As the dome switch 104 is mounted within the push button 100 in a similar central location, and the Arrow F₁ is aligned with and parallel with the cycling direction of the dome switch 104, the dome switch 104 provides a predictable and consistent positive tactile feedback to the user when depressed and released.

Arrows F₂, F₃ illustrate depression forces that may be applied by the user at an upper and lower edges of the push button 100, respectively. As the dome switch 104 remains mounted behind the push button 100 in a central location, the arrows F₂, F₃ are misaligned with the dome switch 104. Thus, application of a force illustrated by arrow F₂ causes a torsional force on the push button 100 in a first direction, in addition to the applied compressive force. Similarly, application of a force illustrated by arrow F₃ causes a torsional force on the push button 100 in an opposite direction, in addition to the applied compressive force. As typical in the prior art, this torsional force on the push button 100 causes rotation of the push button 100 when the dome switch 104 is depressed and released. This rotation yields a less predictable and less consistent positive tactile feedback to the user as compared to that resulting from a more central application of force (e.g., a force illustrated by Arrow F₁), which is generally undesirable.

The presently disclosed technology incorporates a hinge arm 106 that spans the push button 100 and reduces or prevents the push button 100 from rotation caused by the torsional forces on the push button 100 created by a depression force applied by the user at an edge of the push button 100, such as that illustrated by arrows F₂, F₃. As a result, the dome switch 104 provides a predictable and consistent positive tactile feedback to the user similar to that achieved by a centrally applied depression force, such as that illustrated by arrow F₁. This effect is referenced herein as consistent edge performance.

Consistent edge performance may be further defined as the positive tactile feedback of a centrally applied depression force, such as that illustrated by arrow F₁ being substantially same as the positive tactile feedback of a force applied at an edge of the push button 100, such as that illustrated by arrow F₂ or arrow F₃. Substantially the same positive tactile feedback may be considered generally imperceptible variation in requisite force applied to the push button 100 and stroke of the push button 100 required to actuate the dome switch 104, anywhere that the force is applied on the button, for example. Positive tactile feedback may be measured as substantially same if there is less than a 10% variation in force applied to the push button 100 and stroke of the push button 100 required to actuate the dome switch 104, anywhere that the force is applied on the button, for example.

While the push button 100 is illustrated as an oblong rounded rectangular shape, in other implementations it may have another long strip, or any other shape, with or without rounded corners. Further, while the mobile computing device 102 is illustrated as a mobile phone or tablet computer, the push button 100 may be incorporated into any computing device (e.g., tablet computers, a laptop computers, a personal computers, gaming devices, a smart phones, keyboards, mice, or any other discrete device that receives physical user inputs and carries out one or more sets of arithmetic and/or logical operations) or input device for a computing device (e.g., handheld controllers, keyboards, trackpads, and mice). Further, the push button 100 may be applied to vehicles (e.g., automobiles, watercraft, and aircraft), consumer electronics (e.g., cameras, telephones, and home appliances), medical devices, and industrial or commercial machinery.

In some implementations, the push button 100 functions as one or both of a power button and a fingerprint reader. Further, the push button 100 may serve other functions, such as a volume adjuster, or selection key. Still further, a computing device or an input device for a computing device may incorporate multiples of the push button 100 (e.g., each key on a keyboard may incorporate the push button 100). Further still, the push button 100 may incorporate a haptic response (e.g., vibration or other repeated forces or motions) to enhance the tactile feedback of the physical travel of the push button 100.

In some implementations, the push button 100 may be covered by a fabric covering (not shown) that serves to seal the interior of the device 102 from contaminates and hide the seam between the device 102 and the push button 100. The fabric covering permits physical depression of the push button 100 and transmits the positive tactile feedback from the push button 100 to the user. The fabric covering may be less than 0.5 mm thick.

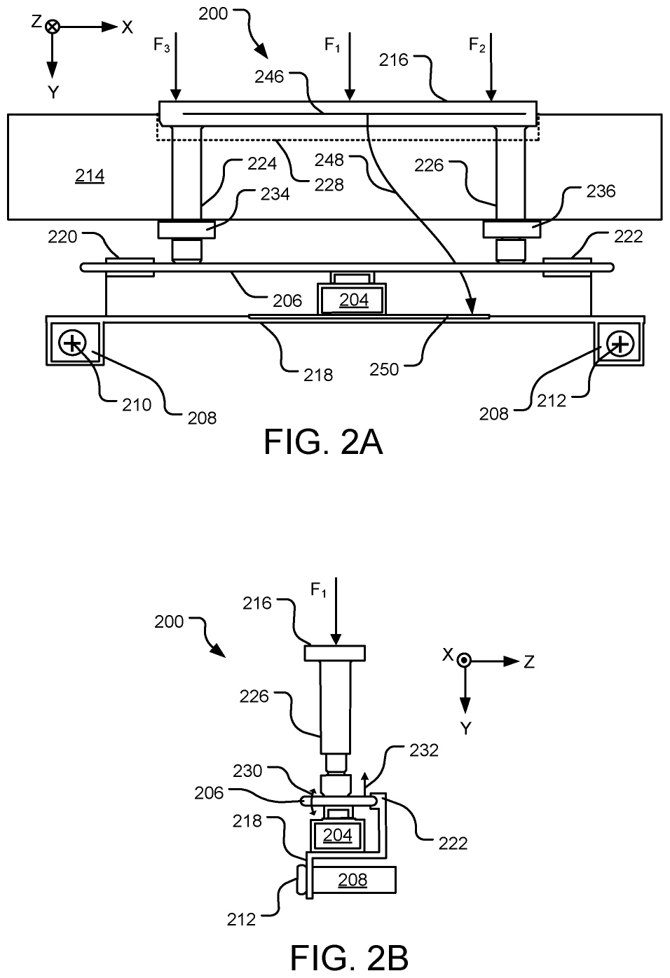

FIG. 2A illustrates a first elevation view of an example push button 200 having consistent edge performance while using a single dome switch 204. X-Y coordinates are provided in FIG. 2A to aid the detailed description, but not limit the scope of the presently disclosed technology. The push button 200 is generally mounted within a chassis 208, which is illustrated in FIG. 2A by two points of attachment 210, 212 and a wall 214 through which a button cap 216 extends. The chassis 208 may be that of any computing device or input device for a computing device.

A dome switch bracket 218 attaches to and spans a distance between the two points of attachment 210, 212 on the chassis 208. The dome switch 204 is mounted on the dome switch bracket 218 so that it is centered underneath the button cap 216. A hinge arm 206 attaches to and spans a distance between two hinge mounts 220, 222 on the dome switch bracket 218. The hinge arm 206 extends between the hinge mounts 220, 222 contacting a top side of the dome switch 204 on one side of the hinge arm 206 and distal ends of button posts 224, 226 of the button cap 216 on the opposite side of the hinge arm 206. In various implementations, utilization of the dome switch bracket 218 provides a technical benefit of being capable of installation as a singular unit capable of preloading the button cap 216 without using the dome switch 204 itself to preload the button cap 216.

The button cap 216 serves as the interface for a user to apply pressure to the push button 200 to selectively actuate the dome switch 204. The button cap 216 includes the button posts 224, 226, which slip-fit through corresponding apertures in the wall 214 of the chassis 208. The button posts 224, 226 and corresponding apertures secure the button cap 216 in position with reference to the chassis 208 in an X-Z plane. Retaining clips 234, 236 (e.g., c-clips) are secured to the distal ends of the button posts 224, 226, respectively, thereby limiting travel of the button cap 216 in the negative y-direction and preventing the button cap 216 from being inadvertently removed from the push button 200.

Arrow F₁ illustrates a depression force applied by a user centrally on the push button 200. As F₁ is applied, the button cap 216 depresses into button cap cavity 228 and the button posts 224, 226 depress in the Y-direction. The button posts 224, 226 transmit F₁ to the hinge arm 206 in substantially equal parts. The hinge arm 206 deflects in the y-direction to permit the dome switch 204 to depress. As the dome switch 204 is mounted within the push button 200 in a similar central location as F₁, and F₁ is aligned with and parallel with the cycling direction of the dome switch 204 (the y-direction in FIG. 2A), the dome switch 204 provides a predictable and consistent positive tactile feedback to the user when depressed and released.

Arrows F₂, F₃ illustrate depression forces that may be applied by the user at non-central locations on the button cap 216 (e.g., at or near an edge of the push button 200). As the dome switch 204 remains centrally mounted within the push button 200, the arrows F₂, F₃ are misaligned with the dome switch 204. As F₂ is applied, the button posts 224, 226 transmit F₂ to the hinge arm 206, with a majority of force applied to the button post 226. The hinge arm 206 rotates in the x-direction and deflects in the y-direction to permit the dome switch 204 to depress. The hinge arm 206 also rotates slightly in the +z direction, however, such rotation is limited by the hinge arm 206 and substantially converted to the y-direction deflection. Similarly, as F₃ is applied, the button posts 224, 226 transmit F₃ to the hinge arm 206, with a majority of force applied to the button post 224. The hinge arm 206 rotates in the x-direction and deflects in the y-direction to permit the dome switch 204 to depress. The hinge arm 206 also rotates slightly in the negative z-direction, however, such rotation is limited by the hinge arm 206 and substantially converted to the y-direction deflection. In other words, the hinge arm 206 is rotatable in x-direction and constrained in rotation about the z-direction by the hinge mounts 220, 222 so that the button cap 216 can be moved up and down in the y-direction, while being limited in rotation about the z-direction. The dome switch bracket 218 remains fixed in place and undeformed. As a result, the button cap 216 has increased travel distance in the y-direction as compared to the prior art.

Thus, application of F₂ causes a torsional force on the push button 200 in the z-direction, in addition to the applied compressive force. Similarly, application of F₃ causes a torsional force on the push button 200 in the negative z-direction, in addition to the applied compressive force. The hinge arm 206 that spans the button posts 224, 226 reduces or eliminates the rotation deflection of the button cap 216 caused by the torsional forces on the push button 200 created by depression forces applied by the user at an edge of the push button 200, such as that illustrated by arrows F₂, F₃. As a result, the dome switch 204 provides a predictable and consistent positive tactile feedback to the user similar to that achieved by a centrally applied depression force, such as that illustrated by F₁. This effect is referenced herein as consistent edge performance.

In other implementations, the dome switch 204 is not centered underneath the button cap 216 but merely placed anywhere convenient between the hinge arm 206 and the dome switch bracket 218. In various implementations, a push button 200 thickness specification may be less than 5.0 mm between the dome switch bracket 218 and a top side (user interface surface) of the button cap 216. Further, the push button 200 have between 0.15 mm and 0.3 mm (or approximately 0.15 mm) of physical travel or stroke to offer the user a perceptible physical travel and positive tactile feedback.

In some implementations, the push button 200 is utilized as a power button for the computing device or input device for the computing device. Further, the push button 200 may also be utilized as a fingerprint reader for granting access to the computing device. In such cases, the button cap 216 includes a fingerprint sensor 246 embedded therein. The fingerprint sensor 246 is communicatively coupled to a printed circuit board (PCB) 250 that receives a signal from the fingerprint sensor 246 (illustrated by arrow 248) and performs fingerprint detection operations and/or forwards the signal on for fingerprint detection operations performed elsewhere within the computing device. In some implementations, the dome switch 204 is mounted on the same PCB 250 that receives a signal from the fingerprint sensor 246, as shown. In other implementations, the dome switch 204 is mounted on its own PCB or is communicatively coupled to a separately-located PCB.

FIG. 2B illustrates a second elevation view of the example push button 200 of FIG. 2A. The wall 214 and the retaining clips 234, 236 are omitted from FIG. 2B for clarity of illustration. As the hinge arm 206 limits deflection in the y-direction and rotation in the z-direction of the button cap 216, overall travel of the push button 200 is limited compared with prior art solutions that freely permit rotation in the z-direction. To allow for additional travel of the push button 200, the dome switch bracket 218 is cantilevered away from the points of attachment 210, 212 so that the hinge arm 206 may rotate in the x-direction in response to application of F₁, F₂, or F₃, as illustrated by arrow 230. As the cantilevered shape of the dome switch bracket 218 has consistent sectional shape in the x-direction (as illustrated in FIG. 2A), variations in the point of application of force between F₁, F₂, or F₃, does not yield substantial variation in x-direction rotation of the dome switch bracket 218. Further, the dome switch bracket 218, the dome switch 204, and the hinge arm 206 can be pre-assembled and subsequently attached to the chassis 208.

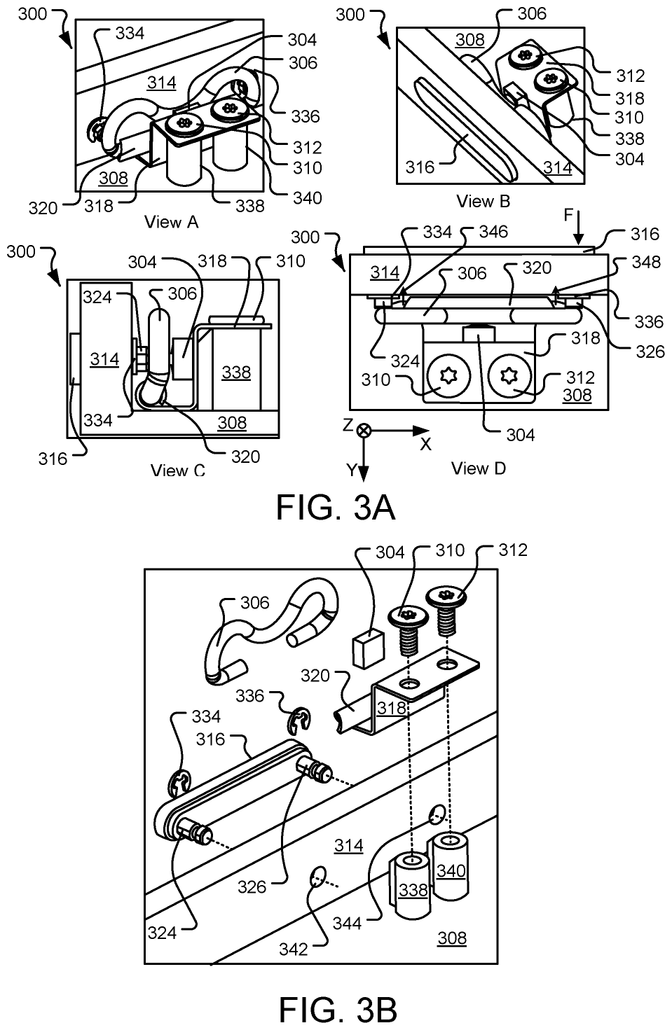

FIG. 3A illustrates several views of another example push button 300 having consistent edge performance while using a single dome switch 304. View A of the push button 300 is a perspective view from an interior of a chassis 308 for the push button 300. View B of the push button 300 is a perspective view from both the interior and an exterior of the chassis 308. View C of the push button 300 is an elevation view from both the interior and the exterior of the chassis 308. View D of the push button 300 is a plan view from both the interior and the exterior of the chassis 308. The chassis 308 may be that of any computing device or input device for a computing device. FIG. 3B illustrates an exploded perspective view of the example push button 300 of FIG. 3A.

The chassis 308 includes a pair of stand-offs 338, 340 for mounting the push button 300. Specifically, a dome switch bracket 318 is attached to the stand-offs 338, 340 using screws 310, 312, respectively, and spans a distance between the stand-offs 338, 340. The dome switch 304 is mounted on the dome switch bracket 318 so that it is centered underneath button cap 316. A hinge arm 306 attaches to a hinge mount 320 on the dome switch bracket 318 that permits the hinge arm 306 to rotate with reference to the dome switch bracket 318.

The button cap 316 serves as the interface for a user to apply pressure to the push button 300 to selectively actuate the dome switch 304. The button cap 316 includes button posts 324, 326, which slip-fit through corresponding apertures 342, 344 in a wall 314 of the chassis 308. The button posts 324, 326 and corresponding apertures 342, 344 secure the button cap 316 in position with reference to the chassis 308. Retaining clips 334, 336 (e.g., c-clips) are secured to the distal ends of the button posts 324, 326, respectively, thereby limiting travel of the button posts 324, 326 out of their corresponding apertures 342, 344 of the push button 300.

The hinge arm 306 extends from the hinge mount 320 contacting a top side of the dome switch 304 and returns to the hinge mount 320 in a curved loop on one side of the hinge arm 306. The hinge arm 306 further extends between distal ends of the button posts 324, 326 of the button cap 316 on the opposite side of the hinge arm 306. The hinge arm 306 may be constructed of stainless-steel spring wire, though other resiliently deflectable materials are contemplated herein (e.g., other metal alloys or plastics (if sufficient room is available to accept a larger plastic piece)) to construct the hinge arm 306.

Referring specifically to View D, Arrow F illustrates a depression force that may be applied by a user at a non-central location on the button cap 316 (e.g., at or near an edge of the push button 300). As F is applied, the button posts 324, 326 transmit F to the hinge arm 306, with a majority of force applied to the button post 326. The hinge arm 306 rotates about the x-axis to permit the dome switch 304 to depress. The hinge arm 306 also rotates in the +z direction, however, such rotation is limited by deflection of the hinge arm 306 and converted to rotation about the x-axis. In other words, the hinge arm 306 is rotatable in x-direction and constrained in rotation about the z-direction by the hinge mount 320 so that the button cap 316 can be moved up and down in the y-direction, while being limited in rotation about the z-direction.

Application of F causes a torsional force on the push button 300 in the positive z-direction, in addition to the applied compressive force. The hinge arm 306 that spans the button posts 324, 326 is constrained by the hinge mount 320 to reduce or eliminate z-direction rotation deflection of the button cap 316 caused by the torsional forces on the push button 300 created by depression forces applied by the user at an edge of the push button 300, such as that illustrated by arrow F. As a result, the dome switch 304 provides a predictable and consistent positive tactile feedback to the user regardless of where on the button cap 316 the force is applied. This effect is referenced herein as consistent edge performance.

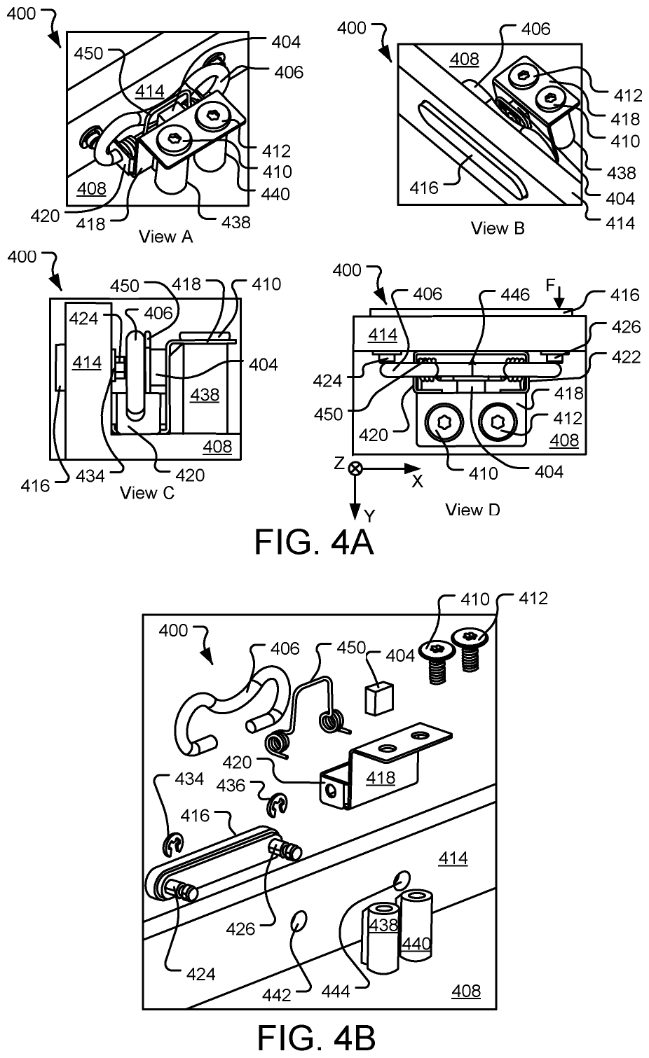

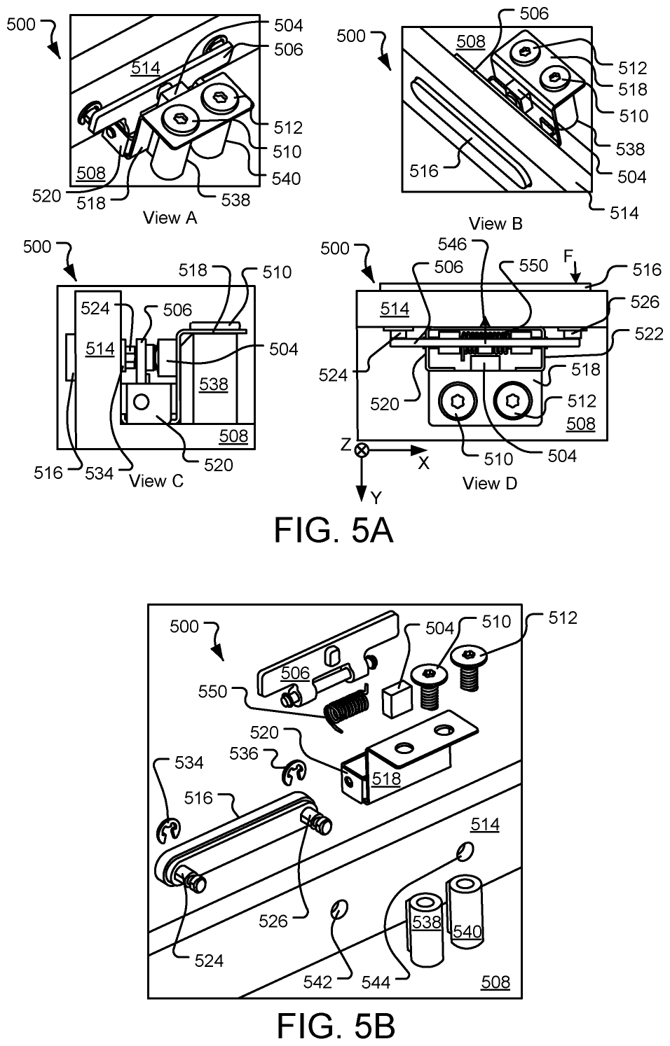

Further, the dome switch bracket 318, the dome switch 304, and the hinge arm 306 can be pre-assembled and subsequently attached to the chassis 308 using the screws 310, 312 in a top-down assembly approach. Still further, the hinge mount 320 of the dome switch bracket 318 includes slanted cut edges, as shown. The slanted cut edges apply a bias in the hinge arm 306 against the button posts 324, 326, as illustrated by arrows 346, 348 in View D. The bias in the hinge arm 306 creates a spring force that can be used to apply the technical benefit of preload on the button posts 324, 326 to take up any slack or perception of looseness in the button cap 316. Other implementations lack the slanted cut edges in the hinge mount 320 and bias the hinge arm 306 using another mechanism (see e.g., FIGS. 4A-4B and 5A-5B).

FIG. 4A illustrates several views of another example push button 400 having consistent edge performance while using a single dome switch 404. View A of the push button 400 is a perspective view from an interior of a chassis 408 for the push button 400. View B of the push button 400 is a perspective view from both the interior and an exterior of the chassis 408. View C of the push button 400 is an elevation view from both the interior and the exterior of the chassis 408. View D of the push button 400 is a plan view from both the interior and the exterior of the chassis 408. The chassis 408 may be that of any computing device or input device for a computing device. FIG. 4B illustrates an exploded perspective view of the example push button 400 of FIG. 4A.

The chassis 408 includes a pair of stand-offs 438, 440 for mounting the push button 400. Specifically, a dome switch bracket 418 is attached to the stand-offs 438, 440 using screws 410, 412, respectively, and spans a distance between the stand-offs 438, 440. The dome switch 404 is mounted on the dome switch bracket 418 so that it is centered underneath button cap 416. A hinge arm 406 attaches to hinge mounts 420, 422 on the dome switch bracket 418 (here, mounting ears on each side of the dome switch bracket 418) that permits the hinge arm 406 to rotate with reference to the dome switch bracket 418.

The button cap 416 serves as the interface for a user to apply pressure to the push button 400 to selectively actuate the dome switch 404. The button cap 416 includes button posts 424, 426, which slip-fit through corresponding apertures 442, 444 in a wall 414 of the chassis 408. The button posts 424, 426 and corresponding apertures 442, 444 secure the button cap 416 in position with reference to the chassis 408. Retaining clips 434, 436 (e.g., c-clips) are secured to the distal ends of the button posts 424, 426, respectively, thereby limiting travel of the button posts 424, 426 out of their corresponding apertures 442, 444 of the push button 400.

The hinge arm 406 extends from the hinge mounts 420, 422 contacting a top side of the dome switch 404 and returns to the hinge mounts 420, 422 in a loop on one side of the hinge arm 406. The hinge arm 406 further extends between distal ends of the button posts 424, 426 of the button cap 416 on the opposite side of the hinge arm 406. The hinge arm 406 may be constructed of stainless-steel spring wire, though other resiliently deflectable materials are contemplated herein (e.g., other metal alloys or plastics (if sufficient room is available to accept a larger plastic piece)) to construct the hinge arm 406. The stainless-steel spring wire may be technically advantageous over formed metal plate as it is easily bent to a desired configuration under high load (above a yield threshold of the stainless-steel) and will hold that shape under the lower loads (below the yield threshold of the stainless-steel), such as those expected to be applied to the push button 400 during use.

Referring specifically to View D, Arrow F illustrates a depression force that may be applied by a user at a non-central location on the button cap 416 (e.g., at or near an edge of the push button 400). As F is applied, the button posts 424, 426 transmit F to the hinge arm 406, with a majority of force applied to the button post 426. The hinge arm 406 rotates about the x-axis to permit the dome switch 404 to depress. The hinge arm 406 also rotates in the +z direction, however, such rotation is limited by deflection of the hinge arm 406 and converted to rotation about the x-axis. In other words, the hinge arm 406 is rotatable in x-direction and constrained in rotation about the z-direction by the hinge mounts 420, 422 so that the button cap 416 can be moved up and down in the y-direction, while being limited in rotation about the z-direction.

Application of F causes a torsional force on the push button 400 in the positive z-direction, in addition to the applied compressive force. The hinge arm 406 that spans the button posts 424, 426 is constrained by the hinge mounts 420, 422 to reduce or eliminate z-direction rotation deflection of the button cap 416 caused by the torsional forces on the push button 400 created by depression forces applied by the user at an edge of the push button 400, such as that illustrated by arrow F. As a result, the dome switch 404 provides a predictable and consistent positive tactile feedback to the user regardless of where on the button cap 416 the force is applied. This effect is referenced herein as consistent edge performance.

The push button 400 further includes a helical spring 450 that applies a bias in the hinge arm 406 against the button posts 424, 426, as illustrated by arrow 446 in View D. The bias applied to the hinge arm 406 can be used to apply the technical benefit of preload on the button posts 424, 426 to take up any slack or perception of looseness in the button cap 416. Other implementations lack the helical spring 450 and implement a different type of spring element or a different structure to bias the hinge arm 406. Further, the dome switch bracket 418, the dome switch 404, the helical spring 450, and the hinge arm 406 can be pre-assembled and subsequently attached to the chassis 408 using the screws 410, 412 in a top-down assembly approach.

FIG. 5A illustrates several views of another example push button 500 having consistent edge performance while using a single dome switch 504. View A of the push button 500 is a perspective view from an interior of a chassis 508 for the push button 500. View B of the push button 500 is a perspective view from both the interior and an exterior of the chassis 508. View C of the push button 500 is an elevation view from both the interior and the exterior of the chassis 508. View D of the push button 500 is a plan view from both the interior and the exterior of the chassis 508. The chassis 508 may be that of any computing device or input device for a computing device. FIG. 5B illustrates an exploded perspective view of the example push button 500 of FIG. 5A.

The chassis 508 includes a pair of stand-offs 538, 540 for mounting the push button 500. Specifically, a dome switch bracket 518 is attached to the stand-offs 538, 540 using screws 510, 512, respectively, and spans a distance between the stand-offs 538, 540. The dome switch 504 is mounted on the dome switch bracket 518 so that it is centered underneath button cap 516. A hinge arm 506 attaches to hinge mounts 520, 522 on the dome switch bracket 518 (here, mounting ears on each side of the dome switch bracket 518) that permits the hinge arm 506 to rotate with reference to the dome switch bracket 518.

The button cap 516 serves as the interface for a user to apply pressure to the push button 500 to selectively actuate the dome switch 504. The button cap 516 includes button posts 524, 526, which slip-fit through corresponding apertures 542, 544 in a wall 514 of the chassis 508. The button posts 524, 526 and corresponding apertures 542, 544 secure the button cap 516 in position with reference to the chassis 508. Retaining clips 534, 536 (e.g., c-clips) are secured to the distal ends of the button posts 524, 526, respectively, thereby limiting travel of the button posts 524, 526 out of their corresponding apertures 542, 544 of the push button 500.

The hinge arm 506 is a plate that extends from the hinge mounts 520, 522 contacting a top side of the dome switch 504 on one side of the hinge arm 506. The hinge arm 506 further extends between distal ends of the button posts 524, 526 of the button cap 516 on the opposite side of the hinge arm 506. The hinge arm 506 may be constructed of a die-cast plate or cut sheet stock of a resiliently deflectable material (e.g., stainless-steel), though other resiliently deflectable materials are contemplated herein (e.g., other metal alloys or plastics (if sufficient room is available to accept a larger plastic piece)). The die-cast plate or cut sheet stock of a resiliently deflectable material may be technically advantageous over spring wire as it may be repeatedly produced to a very specific shape to best fit an associated computing device.

Referring specifically to View D, Arrow F illustrates a depression force that may be applied by a user at a non-central location on the button cap 516 (e.g., at or near an edge of the push button 500). As F is applied, the button posts 524, 426 transmit F to the hinge arm 506, with a majority of force applied to the button post 526. The hinge arm 506 rotates about the x-axis to permit the dome switch 504 to depress. The hinge arm 506 also rotates in the +z direction, however, such rotation is limited by deflection of the hinge arm 506 and converted to rotation about the x-axis. In other words, the hinge arm 506 is rotatable in x-direction and constrained in rotation about the z-direction by the hinge mounts 520, 522 so that the button cap 516 can be moved up and down in the y-direction, while being limited in rotation about the z-direction.

Application of F causes a torsional force on the push button 500 in the positive z-direction, in addition to the applied compressive force. The hinge arm 506 that spans the button posts 524, 526 is constrained by the hinge mounts 520, 522 to reduce or eliminate z-direction rotation deflection of the button cap 516 caused by the torsional forces on the push button 500 created by depression forces applied by the user at an edge of the push button 500, such as that illustrated by arrow F. As a result, the dome switch 504 provides a predictable and consistent positive tactile feedback to the user regardless of where on the button cap 516 the force is applied. This effect is referenced herein as consistent edge performance.

The push button 500 further includes a helical spring 550 that applies a bias in the hinge arm 506 against the button posts 524, 526, as illustrated by arrow 546 in View D. The bias applied to the hinge arm 506 can be used to apply the technical benefit of preload on the button posts 524, 526 to take up any slack or perception of looseness in the button cap 516. Other implementations lack the helical spring 550 and implement a different type of spring element or a different structure to bias the hinge arm 506. Further, the dome switch bracket 518, the dome switch 504, the helical spring 550, and the hinge arm 506 can be pre-assembled and subsequently attached to the chassis 508 using the screws 510, 512 in a top-down assembly approach.

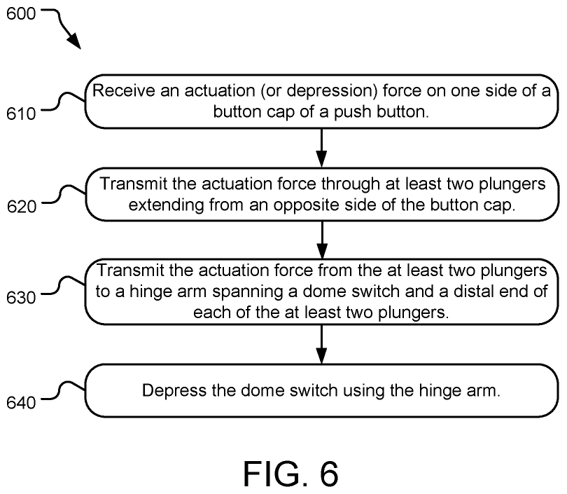

FIG. 6 illustrates example operations 600 for actuating a push button having consistent edge performance while using a single dome switch. In various implementations, the push button has different physical features and arrangements, and may be a power button (with or without a fingerprint sensor) on a smart device or a long strip-shaped button on a keyboard, for example. The single dome switch provides an electric or electronic signal indicating when the push button has been depressed, while providing consistent edge performance if the push button is depressed at or near one of its edges.

A receiving operation 610 receives an actuation (or depression) force on a user interface surface on one side of a button cap. A user applies the actuation force by pressing on the user interface surface of the button cap. A transmitting operation 620 transmits the actuation force through at least two button posts extending from an opposite side of the button cap. The at least two button posts each extend through one of at least two button post apertures in a chassis of a corresponding device. The at least two button posts provide a technical benefit of substantially limiting movement of the button cap in the actuation (or depression) direction.

A transmitting operation 630 transmits the actuation force from the at least two button posts to a hinge arm spanning a dome switch and a distal end of each of the at least two button posts. The dome switch is mounted to a dome switch bracket secured within the chassis and the hinge arm is rotationally mounted to the dome switch bracket. A depressing operation 640 depresses the dome switch using the hinge arm. In various implementations, the hinge arm deflects to absorb torsional forces while the dome switch is depressed. Further, the hinge arm is rotationally constrained to absorb torsional force.

The hinge spanning the button posts reduces or eliminates rotation deflection of the button cap caused by torsional forces on the push button created by the actuation force applied by the user at an edge of the push button. As a result, the dome switch provides a predictable and consistent positive tactile feedback to the user regardless of where on the button cap the force is applied. This effect is referenced herein as consistent edge performance.

Due to the small stroke (e.g., 0.15 mm) of many dome switches, the preload design of the prior art to pre-depress the dome switch is dimensionally sensitive and often requires higher component dimensional accuracy/assembly precision and/or causes the poor manufacturability issue of higher failure rate/cost. In various implementations, the presently disclosed technology employs a new pre-load design without requiring pre-depression of the dome switch that permits a more forgiving tolerance to manufacturing variations.

The operations making up the embodiments of the invention described herein are referred to variously as operations, steps, objects, or modules. Furthermore, the operations may be performed in any order, adding or omitting operations as desired, unless explicitly claimed otherwise or a specific order is inherently necessitated by the claim language.

In various implementations, the dimensions provided herein are approximate and defined as +/−10%. Dimensions provided herein and described as “substantially” is defined as within expected manufacturing tolerances for the disclosed art. In other implementations (e.g., large travel push buttons), the provided dimensions may have proportionally greater values than that specifically defined. Further, other dimensions than those specifically provided are contemplated herein.

A push button according to the presently disclosed technology may comprise a chassis including at least two button post apertures, a dome switch mounted within the chassis, a button cap, and a hinge arm. The button cap includes a user interface surface on one side of the button cap and at least two button posts extending from an opposite side of the button cap, the at least two button posts each extending through one of the at least two button post apertures. The hinge arm spans the dome switch and a distal end of each of the at least two button posts, wherein the hinge arm is rotationally mounted to the chassis.

A push button according to the presently disclosed technology may further comprise a dome switch bracket that mounts the dome switch to the chassis, wherein the dome switch bracket further rotationally mounts the hinge arm to the chassis.

In a push button according to the presently disclosed technology, the dome switch bracket may include a hinge mount to bias the hinge arm away from the dome switch.

A push button according to the presently disclosed technology may further comprise a spring element to bias the hinge arm away from the dome switch.

In a push button according to the presently disclosed technology, the hinge arm may be a curved wire connecting the chassis, the at least two button posts, and the dome switch.

In a push button according to the presently disclosed technology, the hinge arm may be a plate connecting the chassis, the at least two button posts, and the dome switch.

In a push button according to the presently disclosed technology, the hinge arm may rotate about a first axis to permit the button cap to travel.

In a push button according to the presently disclosed technology, the hinge arm may limit rotation about a second axis to limit rotation of the button cap.

In a push button according to the presently disclosed technology, the dome switch may be one of a metal dome switch and a polydome.

A push button according to the presently disclosed technology may include only one dome switch.

In a push button according to the presently disclosed technology, the user interface surface of the button cap may provide an interface for a user to depress the push button.

A method of actuating a push button according to the presently disclosed technology may comprise receiving an actuation force on a user interface surface on one side of a button cap, transmitting the actuation force through at least two button posts extending from an opposite side of the button cap, the at least two button posts each extending through one of at least two button post apertures in a chassis, transmitting the actuation force from the at least two button posts to a hinge arm spanning a dome switch and a distal end of each of the at least two button posts, wherein the dome switch is mounted within the chassis, and wherein the hinge arm is rotationally mounted to the chassis, and depressing the dome switch using the hinge arm.

In a method according to the presently disclosed technology, the hinge arm may deflect to depress the dome switch.

In a method according to the presently disclosed technology, the hinge arm may rotate to permit deflection of the button cap responsive to the actuation force.

A fingerprint-sensing power button for a computing device according to the presently disclosed technology may comprise a chassis including at least two button post apertures, a dome switch mounted within the chassis, a button cap, and a hinge arm. The button cap includes a fingerprint sensor, a user interface surface on one side of the button cap, and at least two button posts on an opposite side of the button cap. The at least two button posts each extend through one of the at least two button post apertures. The hinge arm spans the dome switch and a distal end of each of the at least two button posts, wherein the hinge arm is rotationally mounted to the chassis.

In a fingerprint-sensing power button according to the presently disclosed technology, the dome switch may be mounted to a printed circuit board within the chassis, and the fingerprint sensor is communicatively coupled to the printed circuit board.

A fingerprint-sensing power button according to the presently disclosed technology may further comprise a dome switch bracket that mounts the dome switch to the chassis, wherein the dome switch bracket further rotationally mounts the hinge arm to the chassis.

In a fingerprint-sensing power button according to the presently disclosed technology, the dome switch bracket may include a hinge mount to bias the hinge arm away from the dome switch.

A fingerprint-sensing power button according to the presently disclosed technology may further comprise a spring element to bias the hinge arm away from the dome switch.

A fingerprint-sensing power button according to the presently disclosed technology may include only one dome switch.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A push button comprising:
a chassis including at least two button post apertures;
a dome switch mounted within the chassis;
a button cap including a user interface surface on one side of the button cap and at least two button posts extending from an opposite side of the button cap, the at least two button posts each extending through one of the at least two button post apertures; and
a hinge arm spanning the dome switch and a distal end of each of the at least two button posts, wherein the hinge arm is rotationally mounted to the chassis.

2. The push button of claim 1, further comprising:
a dome switch bracket that mounts the dome switch to the chassis, wherein the dome switch bracket further rotationally mounts the hinge arm to the chassis.

3. The push button of claim 2, wherein the dome switch bracket includes a hinge mount to bias the hinge arm away from the dome switch.

4. The push button of claim 1, further comprising:
a spring element to bias the hinge arm away from the dome switch.

5. The push button of claim 1, wherein the hinge arm is a curved wire connecting the chassis, the at least two button posts, and the dome switch.

6. The push button of claim 1, wherein the hinge arm is a plate connecting the chassis, the at least two button posts, and the dome switch.

7. The push button of claim 1, wherein the hinge arm is to rotate about a first axis to permit the button cap to travel.

8. The push button of claim 1, wherein the hinge arm is to limit rotation about a second axis to limit rotation of the button cap.

9. The push button of claim 1, wherein the dome switch is one of a metal dome switch and a polydome.

10. The push button of claim 1, including only one dome switch.

11. The push button of claim 1, wherein the user interface surface of the button cap provides an interface for a user to depress the push button.

12. A method of actuating a push button comprising:
receiving an actuation force on a user interface surface on one side of a button cap;
transmitting the actuation force through at least two button posts extending from an opposite side of the button cap, the at least two button posts each extending through one of at least two button post apertures in a chassis;
transmitting the actuation force from the at least two button posts to a hinge arm spanning a dome switch and a distal end of each of the at least two button posts, wherein the dome switch is mounted within the chassis, and wherein the hinge arm is rotationally mounted to the chassis; and
depressing the dome switch using the hinge arm.

13. The method of claim 12, wherein the hinge arm deflects to depress the dome switch.

14. The method of claim 12, wherein the hinge arm rotates to permit deflection of the button cap responsive to the actuation force.

15. A fingerprint-sensing power button for a computing device comprising:
a chassis including at least two button post apertures;
a dome switch mounted within the chassis;
a button cap including:
a fingerprint sensor;
a user interface surface on one side of the button cap; and
at least two button posts on an opposite side of the button cap, the at least two button posts each extending through one of the at least two button post apertures; and
a hinge arm spanning the dome switch and a distal end of each of the at least two button posts, wherein the hinge arm is rotationally mounted to the chassis.

16. The fingerprint-sensing power button of claim 15, wherein the dome switch is mounted to a printed circuit board within the chassis, and wherein the fingerprint sensor is communicatively coupled to the printed circuit board.

17. The fingerprint-sensing power button of claim 15, further comprising:
a dome switch bracket that mounts the dome switch to the chassis, wherein the dome switch bracket further rotationally mounts the hinge arm to the chassis.

18. The fingerprint-sensing power button of claim 17, wherein the dome switch bracket includes a hinge mount to bias the hinge arm away from the dome switch.

19. The fingerprint-sensing power button of claim 15, further comprising:
a spring element to bias the hinge arm away from the dome switch.

20. The fingerprint-sensing power button of claim 15, including only one dome switch.
